(19) United States
(12) Patent Application Publication
(10) Pub. No.: US 2012/0104223 A1
(43) Pub. Date: May 3, 2012

(54) AERIAL CABLE GROUND CLEARANCE DEVICE

(76) Inventor: David A. Seddon, Hickory, NC (US)

(21) Appl. No.: 13/248,065

(22) Filed: Sep. 29, 2011

Related U.S. Application Data
(60) Provisional application No. 61/407,731, filed on Oct. 28, 2010.

(51) Int. Cl. F16L 3/16

(52) U.S. Cl. 248/634; 248/560; 248/70

(57) ABSTRACT

An adjustment device that compensates for changes in location of the connection point of an aerial cable to a main cable. The device deflects under varying tension in the cable to maintain the cable at a desired ground clearance.

### PRIORITY APPLICATION

This application claims the benefit of priority under 35 U.S.C. §119 of U.S. Provisional Application Ser. No. 61/407,731, filed on Oct. 28, 2010, the content of which is relied upon and incorporated herein by reference in its entirety.

### TECHNICAL FIELD

The present disclosure relates to methods and apparatus for adjusting the ground clearance for aerial cables.

### BACKGROUND

In order to provide cable access to individual residences, businesses, etc. cables such as electrically conductive, fiber optic, and other types, are connected to an exterior point on a structure. The cables connected to the structure, such as drop cables, are often connected to a larger, “main” cable that is in turn mounted to support poles. Because a structure may be remote from support poles, the drop cable is often connected to a point of the main cable located between the support poles. Connection at a location between support poles is often referred to as “mid-span” attachment, although the term does not require connection at the actual midpoint of the main cable between the poles.

FIG. 1 illustrates a conventional mid-span attachment. In the illustrated arrangement, an aerial drop cable 10 is connected at one end to a main cable 20 at a connection point 30, and to a structure 40 at its other end. Cables supported in this manner hang with a catenary shape. When the main cable 20 is subject wind loading, it may sway back and forth. When the main cable 20 sways toward the structure 40 a distance generally indicated as D (although the cable's motion will be generally arcuate), the elevation of a lowest point of the drop cable 10 drops a distance indicated as H so that the lowest point on the drop cable 10 has a ground clearance C. Minimum ground clearances for aerial cables are regulated to ensure that cables do not strike people or objects beneath the cable, so vertical translation of drop cables must be accounted for when planning aerial installations. In extreme weather, both the main cable 20 and the cable 10 may move vertically and horizontally to such a degree that the aerial cable 10 can strike the ground.

A common solution to ensure minimum ground clearance is to use increased tension when connecting the aerial cable to the structure and to the main cable. Increased tension, however, increases the difficulty of installation and also increases the strain on the aerial cable. The drop cable must therefore be constructed to more stringent specifications, which increases the cost of the cable.

### BRIEF DESCRIPTION OF THE FIGURES

The present embodiments are explained in more detail below with reference to figures which show the exemplary embodiments.

FIG. 1 illustrates a conventional mid-span attachment.

FIG. 2 illustrates a mid-span aerial cable installation according to a first embodiment of the present invention.

FIGS. 3A and 3B illustrate operation of an adjustment device according to the first embodiment.

FIGS. 4A and 4B illustrate operation of an adjustment device according to a second embodiment.

### DETAILED DESCRIPTION

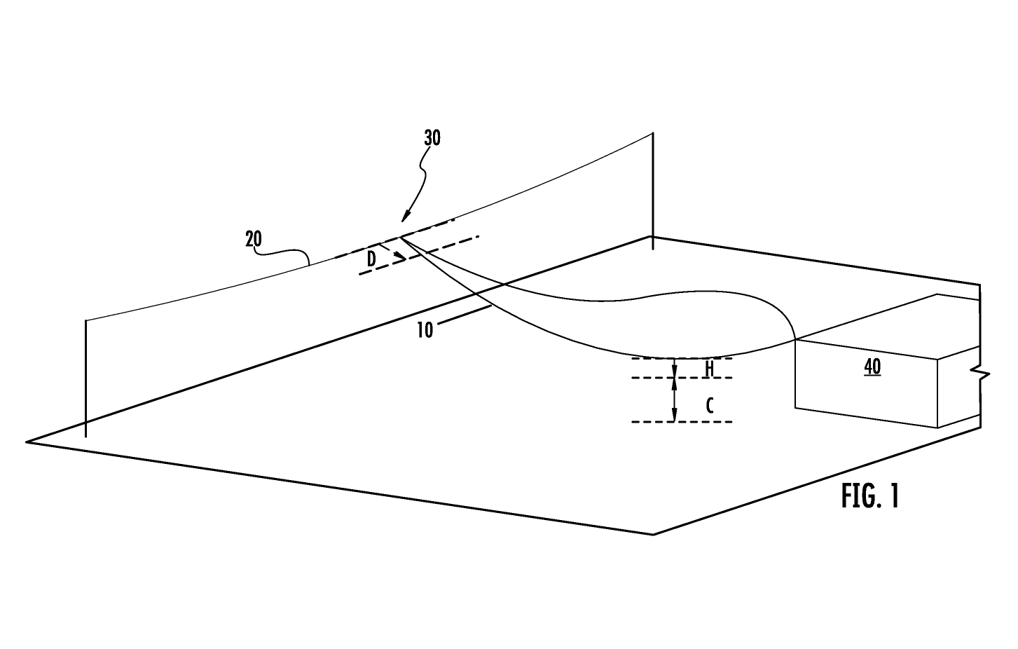

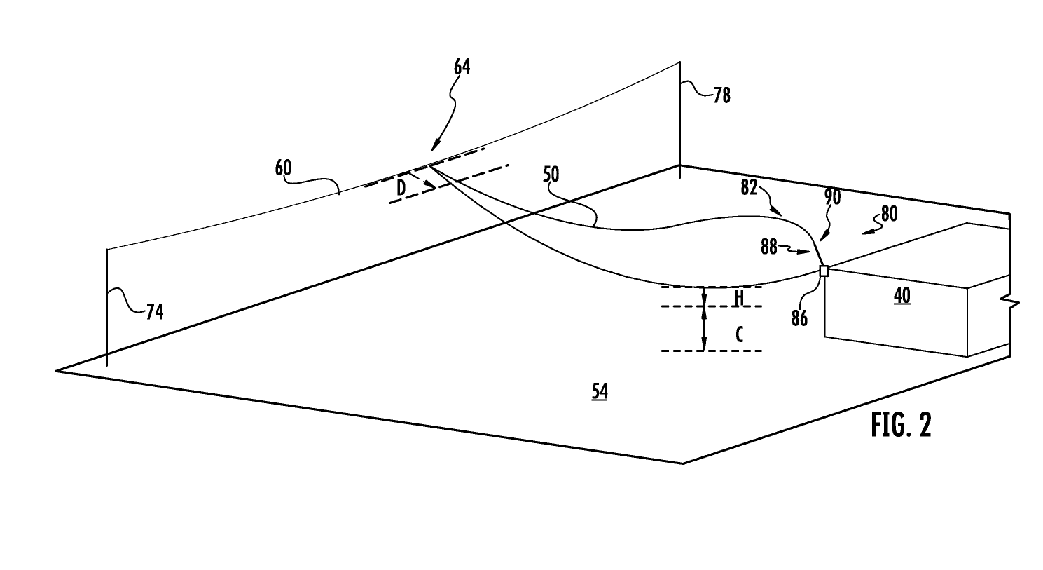

FIG. 2 illustrates a mid-span attachment of an aerial cable 50 according to a first embodiment of the present invention. In FIG. 1, the aerial cable 50 is connected at one end to a main cable 60 at a connection point 64, and at a second end to a structure 40. The main cable 60 is supported by two poles 74, 78 in the illustration, although in practice the main cable may extend for long distances to either side of the poles 74, 78. The aerial cable 50, can be, for example, an aerial drop cable having fiber optic waveguides capable of conveying optical communication signals. The main cable 60 can also be an aerial fiber optic cable, such as a cable sold under the FlexNAP® trademark available from Corning Cable Systems of Hickory N.C.

According to one aspect of the invention, an adjustment device 80 regulates the elevation of the aerial cable 50, as well as reducing lateral translations of the cable, to and compensate for swaying and other motion of the main cable 60. The adjustment device 80 maintains a portion 82 of the cable closest to the structure 40 at a raised elevation, and compensates for movement of the midspan connection point 64 by laterally and/or vertically translating the portion 82 of the cable 50. The adjustment device 80 can be, for example, an elongate flexible rod rigidly secured to the structure 40 at its base 86, and secured to the cable 50 at a connection point 88 at or near its distal end 90. The attachment of the device 80 to the drop cable 50 is along a medial part of the span of the cable 50, and is secure enough so that that relatively high tensions in the drop cable 50 are borne by the device 80. The cable 50 extends past the connection point 88 and can be terminated at the structure 40 to provide optical and/or electrical connectivity from the main cable 60 to the structure 40. Because the device 80 can bear the majority of the tension in the cable 50, the tension in the cable 50 between the cable connection point 88 and the connectivity point(s) at the structure 40 can be minimal.

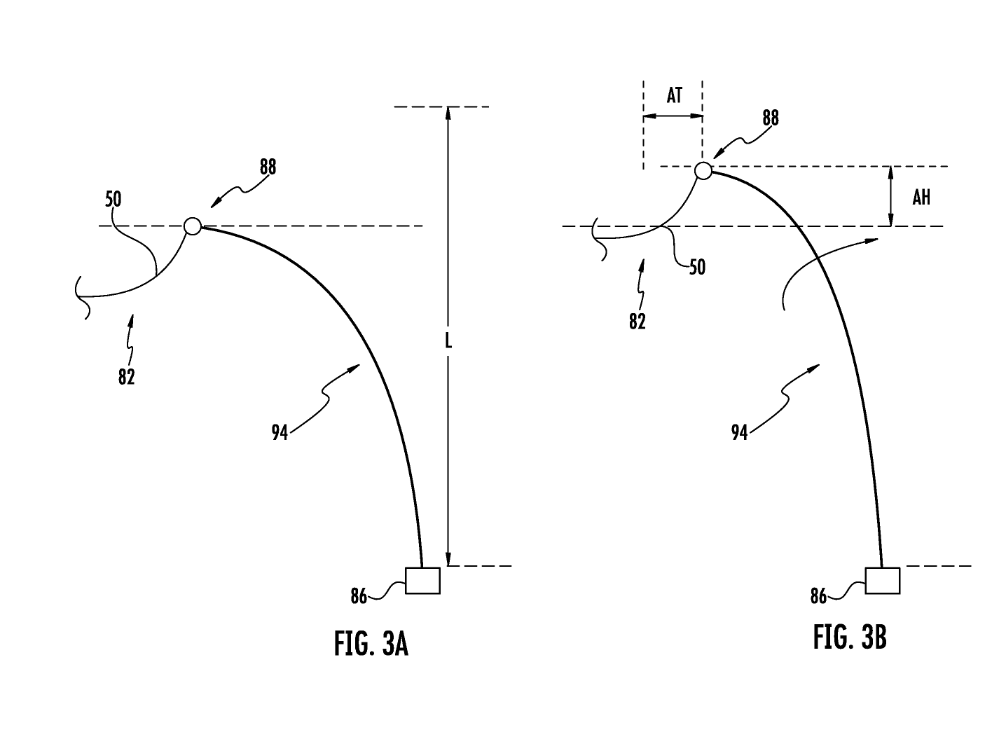

FIGS. 3A and 3B are schematic illustrations of the operation of the adjustment device 80. In FIGS. 3A and 3B, the device 80 is illustrated as an elongate flexible rod 94 with the aerial cable 50 connected to the distal end 90 at the connection point 88. The aerial cable 50 further extends from the connection point 88 down the structure (not shown).

Referring to FIG. 3A, the rod 94 and aerial cable 50 are shown when the main cable 60 (FIG. 2) is under no wind load. Under no wind load, which can be described as “static” conditions, the aerial cable 50 is designed to hang with sufficient ground clearance. When the flexible rod 94 supports the cable 50 under static conditions, static tension in the cable 50 causes the connection point 88 to be deflected laterally away from the structure and toward the main cable 60, and also downwardly. The cable 50 is therefore initially connected to the device 80 so that the rod 94 has a static strain that provides static vertical and lateral deflection of the connection point 88.

FIG. 3B shows the orientation of the rod 94 and cable 50 when the main cable 60 has been subjected to wind loads and is swaying toward the structure. As the connection point 64 with the main cable 60 (FIG. 2) moves toward the structure 40, the entire cable 50 also translates. In conventional arrangements, this would result in the lowest point in the cable 50 having a reduced ground clearance, or unwanted horizontal swaying of the aerial cable, or both. According to the present embodiment, the movement in the cable 50 temporarily lessens the tension in the aerial cable 50, and the rod 94, which was deflected under stress in its static state, deflects upwardly and away from the main cable 60 as the cable tension lessens. The cable 50 is therefore pulled upwardly and translated laterally away from the main cable 60 by an adjustment translation distance AT, and an adjustment height AH. The translations AT, AH are shown is idealized vertical and horizontal values, although the rod 94 may also sway from side to side.

When the midspan connection point 64 translates laterally away from the structure 40, the tension in the cable 50 increases. The rod 94 is sufficiently flexible to deflect under increased tension so that the cable 50 can translate towards the main cable 60 to avoid excessively high tension in the cable 50. The rod 94 can have an undeflected, zero strain length L from base 86 to connection point 88.

The device 80 can have a length L in the range of 0.5-4.0 meters, and can be constructed of materials such as graphite, fiberglass, and composites thereof. The device 80 should be sufficiently flexible to undergo substantial static deflections, yet have a high enough elastic modulus to withstand the stresses induced by wind loading. In a typical installation as shown in FIGS. 2, 3A, and 3B, the adjustment translation distance AT may fall in the range of 0.25-2.0 meters. The adjustment height AH may fall in the range of 0.25-2.0 meters. Lateral, or side to side motion of the connection point 88 may fall in the range of 0.25-2.0 meters.

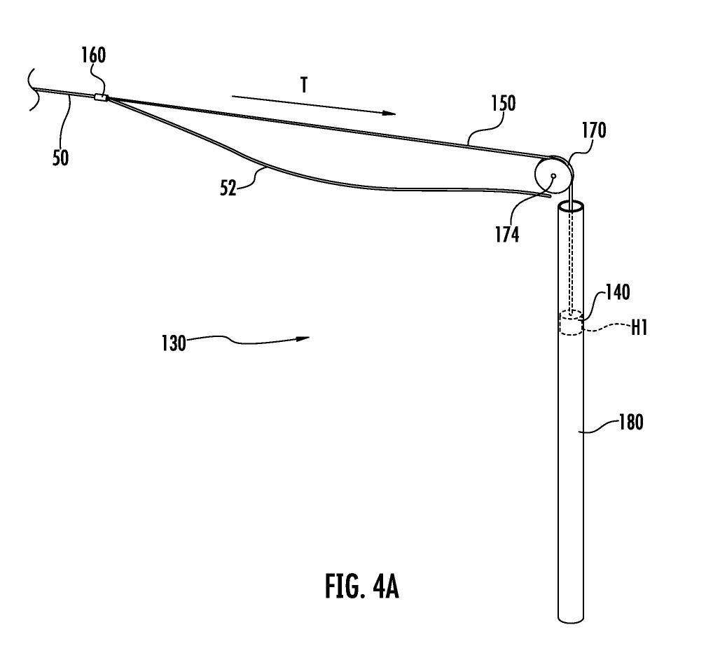

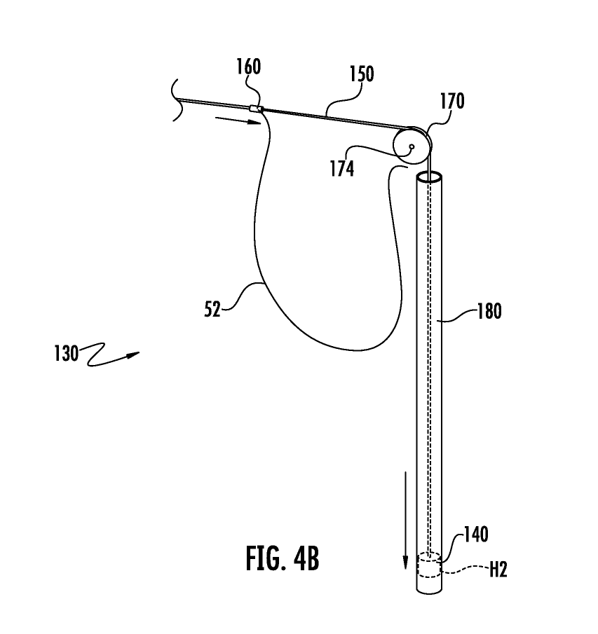

FIGS. 4A and 4B are schematic illustrations of an adjustment device 130 according to another embodiment. The adjustment device 130 has a weight 140 that exerts tension on the cable 50 to regulate the elevation of the cable 50 and thereby compensate for swaying in the main cable 60 (FIG. 2). The weight 140 is connected to a tension cable 150, which is in turn connected to the aerial cable 50 at a connection 160. The tension cable 150 hangs over a pulley 170 that can be supported at the structure 40 on a pin 174. The weight 140 can travel vertically along a vertically extending guide 180, such as, for example, a tube. The weight 140 exerts a tension force T on the tension cable 150, which in turn exerts the tension T on the cable 50. A portion 52 of the cable 50 extends from the connection 160 down to the structure 40 where it can provide various services to the structure. The portion 52 can be relatively tension-free.

In FIG. 4A, the cable aerial cable 50 is shown in its static state, with the weight at a first height H1 in the guide 180. FIG. 4B illustrates the operation of the adjustment device 130 as the cable 50 sags, such as would happen when the main cable 60 sways as shown in FIG. 2. When the cable 50 sags, the weight 140 falls to a height H2, which is below H1. The tension cable 150 then pulls the cable 50 to compensate for the sag in the cable 50, as illustrated by the arrow below the connection 160.

In practice, under shifting winds, the main cable 60 would sway back and forth, and have other irregular motions, so that the aerial cable 50 alternately sag and then be pulled taught in irregular motions. The weight 140 exerts a relatively constant tension on the cable 50 so that the clearance height of the cable 50 can be relatively constant. Lateral motion and other movements of the aerial cable 50 are also inhibited by the adjustment device 130.

According to an alternative embodiment, the adjustment devices 80, 130 could be mounted to the main cable to compensate for sag and other variables at the mid-span attachment.

Many modifications and other embodiments of the present invention, within the scope of the claims will be apparent to those skilled in the art. For instance, the concepts of the present invention can be used with any suitable fiber optic cable design and/or method of manufacture. For instance, the embodiments shown can include other suitable cable components such as an armor layer, coupling elements, different cross-sectional shapes, or the like. Thus, it is intended that this invention covers these modifications and embodiments as well those also apparent to those skilled in the art.

What is claimed is:

1. An aerial cable installation, comprising:
an aerial cable;
an adjustment device having a secured base, wherein
the adjustment device comprises an elongate flexible element with a connection point at an end distal to the base, the connection point being elevated with respect to the base,
a portion of the cable is connected to the adjustment device at the connection point, and
the connection point is capable of vertical and lateral translation with respect to the base in response to varying tension in the aerial cable.

2. The cable installation of claim 1, wherein the elongate element comprises one or more of graphite, fiberglass, and composites thereof.

3. The cable installation of claim 1, wherein the connection point undergoes a lateral translation of at least 0.25 meter when a tension in the aerial cable decreases.

4. The cable installation of claim 2, wherein the connection point undergoes a vertical translation of at least translation of at least 0.25 meter when a tension in the aerial cable decreases.

5. The cable installation of claim 1, wherein the connection point is capable of a lateral translation with respect to the base of at least 10% of a length (L) of the elongate element.

6. The cable installation of claim 5, wherein the connection point is capable of a vertical translation with respect to the base of at least 10% of a length (L) of the elongate element.

7. The cable installation of claim 1, wherein when the aerial cable is not under wind load induced stress, the connection point is deflected downwardly under strain.

8. The cable installation of claim 2, wherein when the aerial cable is not under wind load induced stress, the connection point is deflected laterally away from the base under strain.

9. An aerial cable installation, comprising:
an aerial cable connected at a first end to a main cable;
an adjustment device having a base secured to a structure, and a connection point, wherein
a portion of the aerial cable is connected to the adjustment device at the connection point,
the connection point is capable of vertical and lateral translation in response to varying tension in the cable, the connection point moving away from the main cable when tension decreases in the aerial cable, and
a second end of the cable is connected at the structure.

10. The cable installation of claim 9, wherein the connection point undergoes a lateral translation of at least 0.25 meter when a tension in the cable decreases.

11. The cable installation of claim 10, wherein the connection point undergoes a vertical translation of at least 0.25 meter when a tension in the cable decreases.

12. An aerial cable installation, comprising:
an aerial cable; and
an adjustment device secured at a structure, the adjustment device comprising:
a tension cable connected to the aerial cable; and
a weight connected to the tension cable, wherein
the weight travels vertically in response to movement of the aerial cable.

13. The aerial cable installation of claim 12, wherein the weight is at a first height (H1) in static conditions, and the weight drops to a second height (H2) as the aerial cable sags.

14. The aerial cable installation of claim 13, further comprising a pulley over which the tension cable is supported.
